(19) United States
(12) Patent Application Publication
(10) Pub. No.: US 2025/0044781 A1
(43) Pub. Date: Feb. 6, 2025

(54) MONITORING METHOD, METHOD FOR CALCULATING SN RATIO GAIN, MONITORING DEVICE, AND PROGRAM

(71) Applicant: MITSUBISHI HEAVY INDUSTRIES , LTD., Tokyo (JP)

(72) Inventors: Ichiro NAGANO, Tokyo (JP); Mayumi SAITO, Tokyo (JP); Kuniaki AOYAMA, Takasago City, Hyogo (JP); Keiji EGUCHI, Tokyo (JP)

(21) Appl. No.: 18/719,454

(22) PCT Filed: Nov. 22, 2022
(86) PCT No.: PCT/JP2022/043205

§ 371 Date: Jun. 13, 2024

(30) Foreign Application Priority Data
Jan. 31, 2022 (JP) 2022-012655

(51) Int. Cl. G05B 23/02

(52) U.S. Cl. CPC G05B 23/024

(57) ABSTRACT

A method for calculating an SN ratio gain, in which the magnitude level of the SN ratio gain based on an orthogonal array size for each unit space in a multi-MT method is corrected. The method for calculating an SN ratio gain involves creating a plurality of unit spaces by using data detected by a plurality of sensors provided to a plant, and evaluating the state of the plant using the unit spaces by a multi-MT method, and includes: a step for allocating, for each of the unit spaces, one of the sensors used for creating the unit space to a 2-level orthogonal array, and generating orthogonal arrays for the respective unit spaces; a step for calculating, for each of the orthogonal arrays for the respective unit spaces, an SN ratio for each line of the orthogonal array; and a step for calculating an SN ratio gain.

### TECHNICAL FIELD

The present disclosure relates to a calculation method for an SN ratio gain in a Mahalanobis-Taguchi method, a monitoring method for a plant or the like using the SN ratio gain calculated by the calculation method, a monitoring device, and a program. The present disclosure claims priority based on Japanese Patent Application No. 2022-012655 filed in Japan on Jan. 31, 2022, the contents of which are incorporated herein by reference.

### BACKGROUND ART

PTL 1 discloses a monitoring device that acquires detection data, which is detected by a plurality of sensors provided in a plant of a monitoring target and indicates a state of the plant, calculates a Mahalanobis distance based on a unit space in a Mahalanobis-Taguchi method (MT method), and determines that an operation state of the plant is abnormal when the Mahalanobis distance is equal to or greater than a threshold value. When the monitoring device determines that the operation state of the plant is abnormal, the monitoring device calculates an SN ratio gain for each sensor by using an orthogonal array, and specifies a sensor having a large value of the SN ratio gain as an item related to a factor of the abnormality. As disclosed in PTL 2 (paragraphs 0105 to 0107, and the like), an SN ratio gain of a two-level orthogonal array is generally calculated for each item by a difference between an average value of SN ratios at a first level (using the item) and an average value at a second level (not using the item). Further, PTL 1 discloses a multi-method of the MT method (also referred to as a multi-MT method, a multi-stage MT method, a division and composition method, and the like) in which monitoring is performed based on the Mahalanobis distance from each unit space by dividing blocks at a time of start of the plant and at a time of a rated load operation of the plant and creating the unit space using detection data detected by different sensor groups for each block.

### CITATION LIST

### Patent Literatures

[PTL 1]Japanese Unexamined Patent Application Publication No. 2012-67757
[PTL 2]Japanese Unexamined Patent Application Publication No. 2009-243428

### SUMMARY OF INVENTION

### Technical Problem

The SN ratio gain calculated by a general method is easily affected by a size of the orthogonal array, and, for example, when the size of the orthogonal array is large, the value of the SN ratio gain tends to be small. When the multi-MT method is used, an operation may be performed by setting a threshold value for the SN ratio gain that is common to all the blocks. In this case, when the sizes of the orthogonal arrays of the respective blocks are different from each other, the threshold value is set in accordance with a block having a large value of the SN ratio gain (block having a small size of the orthogonal array). However, when the threshold value is set in this way, erroneous detection tends to occur for the block having a small size of the orthogonal array, and detection delay or detection omission tends to occur for a block having a large size of the orthogonal array.

The present disclosure provides a monitoring method, a calculation method for an SN ratio gain, a monitoring device, and a program capable of solving the above-described problems.

### Solution to Problem

A monitoring method of the present disclosure includes a step of acquiring unit space creation data, which is detected by a plurality of sensors provided in a plant and is for creating a plurality of unit spaces that are predetermined depending on an operation mode and/or a monitoring target, a step of creating the plurality of unit spaces based on the unit space creation data detected by the sensor required for creating each of the unit spaces, a step of acquiring evaluation data, which is detected by the plurality of sensors and is an aggregate of data for evaluating a state of the plant, a step of obtaining a Mahalanobis distance of the evaluation data based on at least some of the plurality of unit spaces, a step of determining the state of the plant based on the Mahalanobis distance and on a predetermined threshold value, and a step of estimating a factor of an abnormality when the abnormality is determined in the step of determining the state of the plant, in which the step of estimating the factor of the abnormality includes a step of allocating, for each of the unit spaces used for determining the state, each of the sensors used for creating the unit space to a two-level orthogonal array with a use of the sensor as a first level and a non-use of the sensor as a second level to create an orthogonal array for each of the unit spaces, a step of calculating a larger-is-better SN ratio of each row of the orthogonal array for each of the orthogonal arrays for each of the unit spaces, a step of calculating an SN ratio gain by calculating a difference between a total value of the larger-is-better SN ratios at the first level and a total value of the larger-is-better SN ratios at the second level for each of the sensors in each of the orthogonal arrays for each of the unit spaces, and a step of specifying the sensor for which the SN ratio gain exceeding a predetermined threshold value for the SN ratio gain is calculated as a sensor related to the factor of the abnormality, based on the SN ratio gain calculated for each of the sensors and on the threshold value for the SN ratio gain.

A calculation method for an SN ratio gain of the present disclosure includes, when a plurality of unit spaces are created based on data detected by a plurality of sensors provided in a plant, and a state of the plant is evaluated by a multi-MT method based on at least some of the plurality of unit spaces, a step of allocating, for each of the unit spaces, each of the sensors used for creating the unit space to a two-level orthogonal array with a use of the sensor as a first level and a non-use of the sensor as a second level to create an orthogonal array for each of the unit spaces, a step of calculating a larger-is-better SN ratio of each row of the orthogonal array for each of the orthogonal arrays for each of the unit spaces, and a step of calculating an SN ratio gain by calculating a difference between a total value of the larger-is-better SN ratios at the first level and a total value of the larger-is-better SN ratios at the second level for each of the sensors in each of the orthogonal arrays for each of the unit spaces.

A monitoring device of the present disclosure includes means for acquiring unit space creation data, which is detected by a plurality of sensors provided in a plant and is for creating a plurality of unit spaces that are predetermined depending on an operation mode and/or a monitoring target, means for creating the plurality of unit spaces based on the unit space creation data detected by the sensor required for creating each of the unit spaces, means for acquiring evaluation data, which is detected by the plurality of sensors and is an aggregate of data for evaluating a state of the plant, means for obtaining a Mahalanobis distance of the evaluation data based on at least some of the plurality of unit spaces, means for determining the state of the plant based on the Mahalanobis distance and on a predetermined threshold value, and means for estimating a factor of an abnormality when the abnormality is determined in the step of determining the state of the plant, in which the means for estimating the factor of the abnormality allocates, for each of the unit spaces used for determining the state, each of the sensors used for creating the unit space to a two-level orthogonal array with a use of the sensor as a first level and a non-use of the sensor as a second level to create an orthogonal array for each of the unit spaces, calculates a larger-is-better SN ratio of each row of the orthogonal array for each of the orthogonal arrays for each of the unit spaces, calculates an SN ratio gain by calculating a difference between a total value of the larger-is-better SN ratios at the first level and a total value of the larger-is-better SN ratios at the second level for each of the sensors in each of the orthogonal arrays for each of the unit spaces, and specifies the sensor for which the SN ratio gain exceeding a predetermined threshold value for the SN ratio gain is calculated as a sensor related to the factor of the abnormality, based on the SN ratio gain calculated for each of the sensors and on the threshold value for the SN ratio gain.

A program of the present disclosure causes a computer to execute a process including a step of acquiring unit space creation data, which is detected by a plurality of sensors provided in a plant and is for creating a plurality of unit spaces that are predetermined depending on an operation mode and/or a monitoring target, a step of creating the plurality of unit spaces based on the unit space creation data detected by the sensor required for creating each of the unit spaces, a step of acquiring evaluation data, which is detected by the plurality of sensors and is an aggregate of data for evaluating a state of the plant, a step of obtaining a Mahalanobis distance of the evaluation data based on at least some of the plurality of unit spaces, a step of determining the state of the plant based on the Mahalanobis distance and on a predetermined threshold value, and a step of estimating a factor of an abnormality when the abnormality is determined in the step of determining the state of the plant, in which the step of estimating the factor of the abnormality includes a step of allocating, for each of the unit spaces used for determining the state, each of the sensors used for creating the unit space to a two-level orthogonal array with a use of the sensor as a first level and a non-use of the sensor as a second level to create an orthogonal array for each of the unit spaces, a step of calculating a larger-is-better SN ratio of each row of the orthogonal array for each of the orthogonal arrays for each of the unit spaces, a step of calculating an SN ratio gain by calculating a difference between a total value of the larger-is-better SN ratios at the first level and a total value of the larger-is-better SN ratios at the second level for each of the sensors in each of the orthogonal arrays for each of the unit spaces, and a step of specifying the sensor for which the SN ratio gain exceeding a predetermined threshold value for the SN ratio gain is calculated as a sensor related to the factor of the abnormality, based on the SN ratio gain calculated for each of the sensors and on the threshold value for the SN ratio gain.

### Advantageous Effects of Invention

According to the monitoring method, the calculation method for an SN ratio gain, the monitoring device, and the program described above, it is possible to calculate an SN ratio gain less affected by a size of an orthogonal array. According to the monitoring method, the monitoring device, and the program described above, a factor of an abnormality can be estimated with high accuracy at an early stage.

### BRIEF DESCRIPTION OF DRAWINGS

FIG. 1 is a diagram showing an example of a monitoring system according to an embodiment.

FIG. 2 is a diagram showing an example of a two-level orthogonal array.

FIG. 3 is a diagram showing a relationship between a magnitude of an SN ratio gain and a size of an orthogonal array according to the embodiment.

FIG. 4A is a diagram showing a relationship between a general SN ratio gain and a threshold value in a multi-MT method.

FIG. 4B is a diagram showing a relationship between a correction SN ratio gain and a threshold value according to the embodiment.

FIG. 5A is a flowchart showing an example of plant monitoring processing according to the embodiment.

FIG. 5B is a flowchart showing an example of calculation processing of a correction SN ratio gain according to the embodiment.

FIG. 6 is a diagram showing an example of a hardware configuration of a monitoring device according to the embodiment.

### DESCRIPTION OF EMBODIMENTS

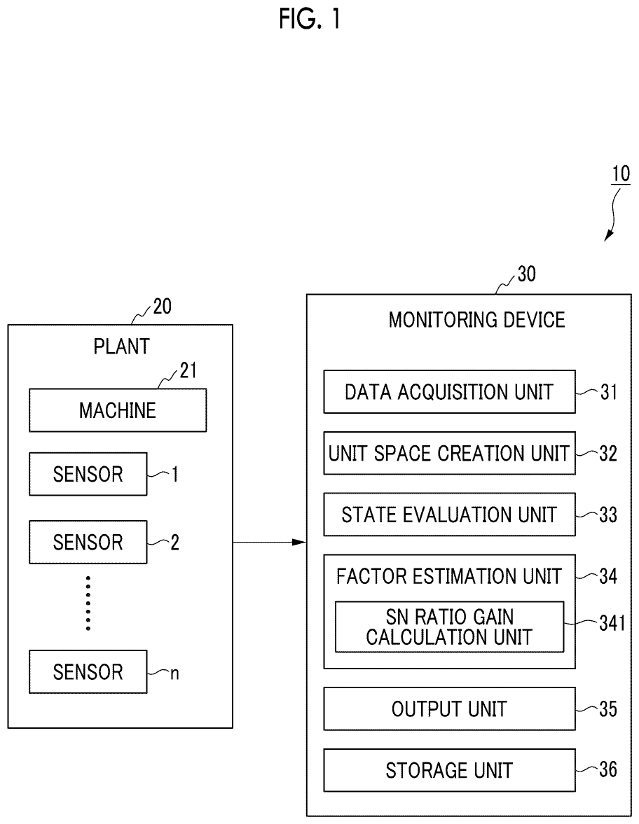

Hereinafter, a monitoring method and a calculation method for an SN ratio gain of the present disclosure will be described with reference to FIGS. 1 to 6. In the following description, the same reference numerals are assigned to configurations having the same or similar functions. Redundant descriptions of such configurations may be omitted.

### (Configuration of Monitoring System)

FIG. 1 is a diagram showing an example of a monitoring system according to an embodiment. A monitoring system 10 shown in FIG. 1 includes a plant 20 of a monitoring target and a monitoring device 30. The plant 20 includes a machine 21 such as a gas turbine or a generator, and sensors 1 to n for detecting states of the machine 21 and an environment in which the machine 21 operates. The plant 20 and the monitoring device 30 are communicably connected by a network or the like. For example, detection data detected by the sensors 1 to n is transmitted to the monitoring device 30 in real time, and the monitoring device 30 acquires the detection data. The monitoring device 30 includes a data acquisition unit 31, a unit space creation unit 32, a state evaluation unit 33, a factor estimation unit 34, an output unit 35, and a storage unit 36.

The data acquisition unit 31 acquires the detection data detected by the sensors 1 to n. For example, when a facility 21 includes the gas turbine and the generator, the sensors 1 to n are sensors that detect a temperature, a pressure, a vibration, a rotation speed, an output of the generator, and the like in each part of the gas turbine. The data acquisition unit 31 acquires the detection data and stores the detection data in the storage unit 36. The detection data acquired by the data acquisition unit 31 includes unit space creation data for creating a unit space in a Mahalanobis-Taguchi (MT) method and evaluation data for evaluating an operation state of the plant 20. The unit space creation data is, for example, the detection data detected by the sensors 1 to n when the plant 20 was operating normally in the past. The evaluation data is detection data, which is detected by the sensors 1 to n of the plant 20 during operation and represents a current state of the plant 20.

The unit space creation unit 32 creates a unit space for calculating a Mahalanobis distance by using the unit space creation data acquired by the data acquisition unit 31. The unit space is an aggregate of data that is used as a reference for a determination when determining whether or not the operation state of the plant 20 is normal. Since a creation method for the unit space is known, the description thereof will be omitted in the present specification. When the plant 20 is monitored by the multi-MT method, the unit space creation unit 32 creates the unit space, for example, for each operation mode or monitoring target of the plant 20. The operation mode includes different operation modes of the plant 20, such as a magnitude of an operation load, a start, and a stop. For example, regarding the operation mode of the plant 20, the unit space creation unit 32 creates the unit space for determining whether or not the operation state of the plant 20 during a start operation is normal by using unit space creation data detected by at least some of the sensors 1 to n when the plant 20 is normally started. For example, the unit space creation unit 32 uses the unit space creation data detected by at least some of the sensors 1 to n when the plant 20 is normally operated at a rated load to create a unit space (referred to as a rated load operation unit space) for determining whether or not the operation state of the plant 20 during the rated load operation is normal. Similarly, the unit space creation unit 32 may create the unit space for each operation load of the plant 20. Regarding an evaluation target, when the plant 20 includes the gas turbine, the unit space creation unit 32 creates the unit space for each monitoring target by using unit space creation data measured by a sensor necessary for evaluating the monitoring target among the sensors 1 to n for each site or state quantity of the monitoring target, such as a blade pass temperature, a bearing, a disc cavity temperature, a shaft vibration, and a filter. Each of the time of the start, the time of the rated load operation, the blade pass temperature, the bearing, the disc cavity temperature, the shaft vibration, the filter, and the like described as an example here is an example of a block (group) in the multi-MT method. The unit space of each block is created by unit space creation data detected by different types of sensor groups. The unit space creation unit 32 stores each created unit space in the storage unit 36.

The state evaluation unit 33 determines whether or not the state of the plant 20 is normal based on the unit space created by the unit space creation unit 32 and on the evaluation data acquired by the data acquisition unit 31. For example, the state evaluation unit 33 extracts detection data detected by the same type of sensors as the sensors used for creating the unit spaces from the evaluation data, and calculates the Mahalanobis distance from the unit space of the extracted detection data group (aggregate of data). The Mahalanobis distance is a measure of a magnitude of a difference between a reference sample expressed as the unit space and a newly obtained sample (extracted detection data group). Since a calculation method for the Mahalanobis distance is known, the description thereof will be omitted in the present specification. For example, when the sensors used for creating the rated load operation unit spaces of the plant 20 are sensors 1 to 11, the state evaluation unit 33 extracts a detection data group detected by the sensors 1 to 11 from the evaluation data acquired by the data acquisition unit 31 in a case of evaluating the state of the plant 20 during the rated load operation, and calculates the Mahalanobis distance between the extracted detection data group and the rated load operation unit space. Next, the state evaluation unit 33 determines whether or not an abnormality has occurred in the plant 20 during the rated load operation based on the calculated Mahalanobis distance. Specifically, when the Mahalanobis distance is equal to or less than a predetermined threshold value, the state evaluation unit 33 determines that the state of the plant 20 is normal, and when the Mahalanobis distance exceeds the threshold value, the state evaluation unit 33 determines that the state of the plant 20 is abnormal. The state evaluation unit 33 determines the state of the plant 20 by using a plurality of unit spaces of blocks required for monitoring. For example, the state evaluation unit 33 determines the state of the plant 20 based on the rated load operation unit space and on the unit space for each monitoring target during the rated load operation.

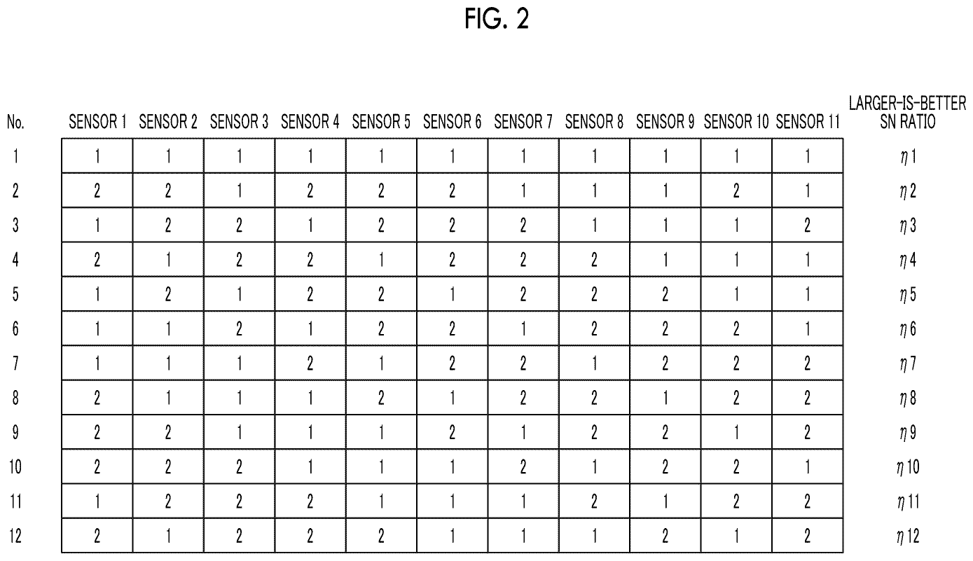

The factor estimation unit 34 estimates a factor of the abnormality when the state evaluation unit 33 determines that the operation state of the plant 20 is abnormal. The factor estimation unit 34 has an SN ratio gain calculation unit 341. The SN ratio gain calculation unit 341 calculates an SN ratio having a larger-is-better characteristic based on an orthogonal array in the MT method, and calculates a larger-is-better SN ratio gain from the SN ratio having the larger-is-better characteristic. In this case, the SN ratio gain calculation unit 341 calculates a larger-is-better SN ratio gain that is less likely to be affected by a difference in a size of an orthogonal array between the blocks as compared with a general larger-is-better SN ratio gain. Hereinafter, the larger-is-better SN ratio gain less likely to be affected by the difference in the size of the orthogonal array between the blocks is referred to as a “correction SN ratio gain”. The SN ratio having the larger-is-better characteristic may be referred to as a larger-is-better SN ratio, and the general larger-is-better SN ratio gain may be referred to as an SN ratio gain. A calculation method for the correction SN ratio gain and a difference between the correction SN ratio gain and a general SN ratio gain will be described with reference to FIGS. 2 to 4B. The factor estimation unit 34 compares a correction SN ratio gain calculated by the SN ratio gain calculation unit 341 with a predetermined alarm threshold value, and when the correction SN ratio gain exceeds the alarm threshold value, the factor estimation unit 34 estimates an item (sensor) of an orthogonal array, which corresponds to the correction SN ratio gain, as the factor of the abnormality. As disclosed in PTL 1, the SN ratio gain calculated based on the orthogonal array has a property of being large for an abnormal item, and the factor of the abnormality can be specified by confirming the item having the large SN ratio gain. This also applies to the “correction SN ratio gain” of the present embodiment.

The output unit 35 outputs a determination result for the operation state of the plant 20 via the state evaluation unit 33 or the factor of the abnormality estimated by the factor estimation unit 34. Examples of the output include display on a display, output to an electronic file, transmission of data to an outside, printing on a paper or a sheet, and audio output.

The storage unit 36 stores a computer program and data for realizing a monitoring method for the plant 20 according to the present embodiment, the data acquired by the data acquisition unit 31, the unit space created by the unit space creation unit 32, and the like. The storage unit 36 may be provided outside the monitoring device 30, and the monitoring device 30 may be configured to access to the storage unit 36 via a communication line.

### (Calculation Method for Correction SN Ratio Gain)

Next, a calculation method for a correction SN ratio gain according to the present embodiment will be described with reference to FIG. 2.

FIG. 2 shows an example of a two-level orthogonal array. Each column of the orthogonal array shown in FIG. 2 is called an item, and a factor of an analysis target is allocated to each item. A value that each item can take is referred to as a level, and in a case of a two-level system, each item takes a value of either “using the item” (first level) or “not using the item” (second level). For values of 1 and 2 of each cell of the orthogonal array, 1 means “using the item” and 2 means “not using the item”. In the present embodiment, the factor is a sensor, and any one of the sensors 1 to n is allocated to each column. In the example of FIG. 2, the sensors 1 to 11 are allocated. Each row of the orthogonal array is a number (experimental number) allocated to each combination of the factors. For example, a first row (No=1) of the orthogonal array of FIG. 2 shows a combination when all the sensors 1 to 11 are used, and a second row (No=2) shows a combination when only sensors 3, 7, 8, 9, and 11 are used. In the multi-MT method, the orthogonal array is created for each block. The orthogonal array shown in FIG. 2 is an orthogonal array created for a block in which the unit space is created by using the unit space creation data detected by the sensors 1 to 11.

In the MT method, an SN ratio is calculated for each row. The larger-is-better SN ratio is calculated by Equation (1).

$$η = - 10 \cdot log \{ ( 1 / {D}_{1}^{2} + 1 / {D}_{2}^{2} + … + 1 / {D}_{m}^{2} ) / m \} \qquad ( 1 )$$

Here, Dₓ² (x=1 to m) is a square of the Mahalanobis distance (MD), and m is the number of data. For example, it is assumed that the detection data of the sensors 1 to 11 can be acquired in a one-minute cycle. When the larger-is-better SN ratio is calculated by using three samples of data going back from the last acquired latest detection data, m is 3, and when the larger-is-better SN ratio is calculated by using only the last acquired latest detection data, m is 1. The SN ratio gain calculation unit 341 calculates larger-is-better SN ratios η1 to η12 of each row of the orthogonal array by using Equation (1).

Next, the SN ratio gain calculation unit 341 calculates the correction SN ratio gain for each of the sensors 1 to 11 by using the larger-is-better SN ratios η1 to η12. The correction SN ratio gain is calculated by a difference between a total value of the larger-is-better SN ratios at the first level and a total value of the larger-is-better SN ratios at the second level among the larger-is-better SN ratios calculated for each row of the two-level orthogonal array. For example, the correction SN ratio gain of the sensor 1 is calculated by Equation (2).

Correction SN ratio gain of sensor 1=(η1+η3+η5+η6+η7+η11)−(η2+η4+η8+η9+η10+η12) (2)

Here, η1, η3, η5, η6, η7, and η11 are larger-is-better SN ratios calculated for rows in which the sensor 1 is at the first level, and η2, η4, η8, η9, η10, and η12 are larger-is-better SN ratios calculated for rows in which the sensor 1 is at the second level.

Similarly, the correction SN ratio gain of the sensor 2 is calculated by (η1+η4+η6+η7+η8+η12)−(η2+η3+η5+η9+η10+η11), and the correction SN ratio gain of the sensor 11 is calculated by (η1+η2+η4+η5+η6+η10)−(η3+η7+η8+η9+η11+η12). The same applies to the other sensor 3 or the like.

For comparison, the general SN ratio gain will be described. The general SN ratio gain is calculated by a difference between an average value of the larger-is-better SN ratios at the first level and an average value of the larger-is-better SN ratios at the second level among the larger-is-better SN ratios calculated for each row of the two-level orthogonal array. For example, the correction SN ratio gain of the sensor 1 is calculated by Equation (2′).

$$SN ratio gain of sensor 1 = ( ( η 1 + η 3 + η 5 + η 6 + η 7 + η 11 ) \div 6 ) - ( η 2 + η 4 + η 8 + η 9 + η 10 + η 12 ) \div 6 ) \qquad ( {2}^{′} )$$

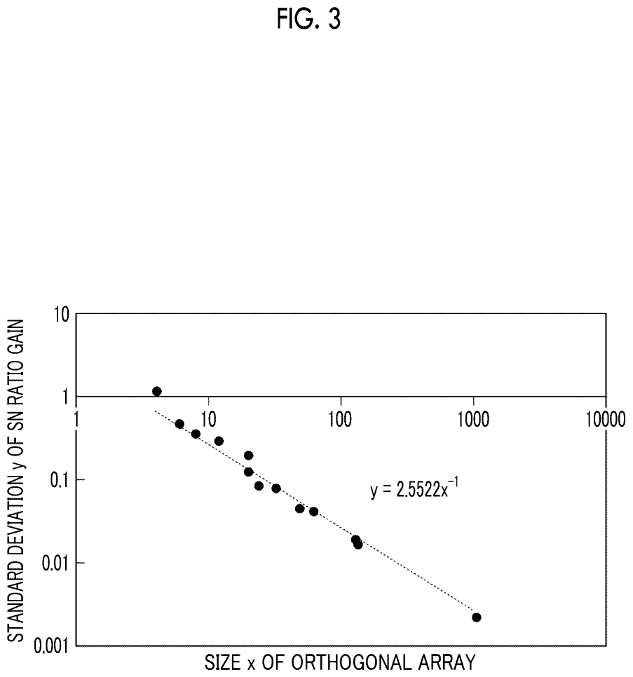

As described above, in the calculation of the general SN ratio gain, each of the average values of the larger-is-better SN ratios at the first level and the second level is used, so that division is performed by “6” in the above example. The value “6” is related to the size of the orthogonal array (for example, in a case of FIG. 2, the size of the orthogonal array can be “12” in terms of the number of rows) (number of rows÷2), and the size of the orthogonal array has a positive correlation with the number of factors, that is, the number of sensors. FIG. 3 shows a relationship between standard deviation of the general SN ratio gain and the size of the orthogonal array. In FIG. 3, a vertical axis y of a graph indicates the standard deviation of the general SN ratio gain, and a horizontal axis x indicates the size of the orthogonal array. Each point of the graph of FIG. 3 is obtained by performing a desk calculation of the general SN ratio gain and the standard deviation thereof when the size of the orthogonal array is changed (number of sensors is changed) for a block targeting a predetermined sensor group and plotting the relationship between the size of the orthogonal array and the standard deviation of the SN ratio gain. As a result of the analysis, as shown in the drawing, it was confirmed that the size of the orthogonal array and the standard deviation of the SN ratio gain were inversely proportional to each other. In general, the standard deviation tends to increase as an average value of data increases. When the general tendency is combined with an analysis result of FIG. 3, it is found that there is a tendency that the SN ratio gain is decreased as the size of the orthogonal array is increased, and the SN ratio gain is increased as the size of the orthogonal array is decreased. Since the size of the orthogonal array has a positive correlation with the number of sensors, the above-described findings can be rephrased that there is a tendency that, as the number of sensors used for creating the unit spaces of a certain block is increased, the SN ratio gain calculated for the sensors of the block is decreased, and as the number of sensors is decreased, the SN ratio gain calculated for the sensors of the block is increased.

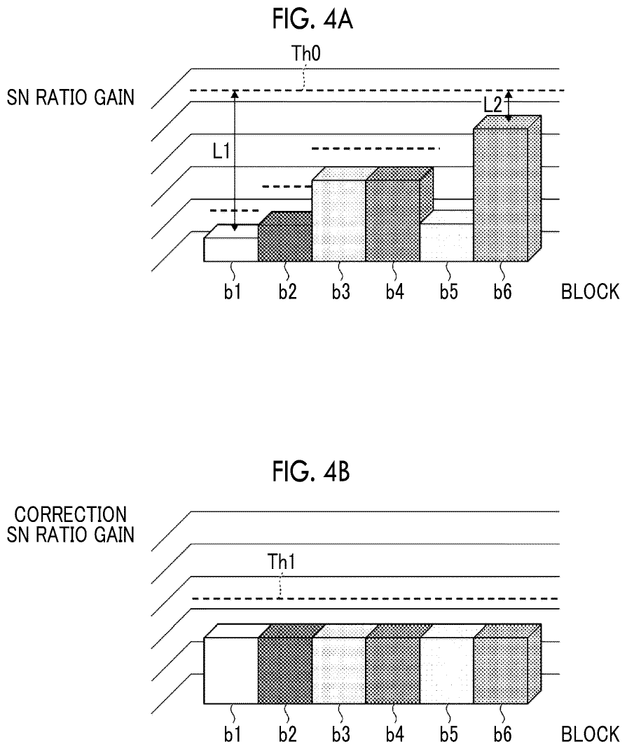

As a result, in each block set according to the operation mode or the monitoring target of the plant 20 described above, since the number of sensors is different for each block, the SN ratio gain calculated by a general method for a block having a large number of sensors tends to be smaller than the general SN ratio gain calculated for a block having a small number of sensors. FIG. 4A shows an example of the general SN ratio gain calculated for the block having a large number of sensors and the block having a small number of sensors. A vertical axis of FIG. 4A indicates a magnitude of the SN ratio gain calculated by the general method, and a horizontal axis indicates the block. Gb1 to Gb6 are SN ratio gains for each block. For example, the SN ratio gain Gb1 represents the SN ratio gain calculated for a certain sensor of a block b1. When the block b1 and a block b6 are compared with each other among blocks b1 to b6, the block b1 is a block having a larger number of sensors than the block b6. As a result, as shown in the drawing, as expected from the above-described findings, the SN ratio gain Gb1 is a value smaller than the SN ratio gain Gb6. Here, it is assumed that the same alarm threshold value Th0 is set for the blocks b1 to b6 to estimate the factor of the abnormality. That is, it is estimated that a sensor of which the value of the SN ratio gain exceeds the alarm threshold value Th0 is related to the factor of the abnormality. As a result, for example, in the sensor of the block b1, a difference L1 between the alarm threshold value Th0 and the SN ratio gain Gb1 is excessively large, and detection delay or detection omission is likely to occur. In a sensor of the block b6, the difference L1 between the alarm threshold value Th0 and the SN ratio gain Gb6 is excessively small, and erroneous detection is likely to occur.

Meanwhile, in the correction SN ratio gain according to the present embodiment in which a correction for reducing an influence of the difference in the orthogonal array size between the blocks is performed, there is a possibility that a difference in the magnitude of the SN ratio gain between the blocks based on the orthogonal array size can be reduced. For example, when the number of rows of the orthogonal array is adopted as the size of the orthogonal array, and a size (number of rows) of an orthogonal array of the block b1 is denoted by V1 and a size of an orthogonal array of the block b6 is denoted by V6, V1>V6. In the calculation of the correction SN ratio gain described above, the correction SN ratio gain is calculated by the difference between the total values of the larger-is-better SN ratios without division by a value proportional to the orthogonal array size (number of rows÷2). As a result, a correction SN ratio gain for the block b1 is SN ratio gain Gb1×(V1÷2), and a correction SN ratio gain for the block b6 is SN ratio gain Gb6×(V6÷2), and a magnitude relationship between a correction SN ratio gain Gb1′ for the block b1 and a correction SN ratio gain Gb6′ for the block b6 may be improved as compared with the relationship shown in FIG. 4A.

FIG. 4B shows an example of a case in which the difference in the magnitude of the SN ratio gain between the blocks due to the influence of the orthogonal array size described with reference to FIG. 3 is improved by calculating the correction SN ratio gain instead of the general SN ratio gain. Correction SN ratio gains Gb1′ to Gb6′ calculated for the blocks b1 to b6 shown in FIG. 4B are all the same values. In such a case, when the same alarm threshold value Th1 is set for the blocks b1 to b6 and the factor of the abnormality is estimated, a difference between the alarm threshold value Th1 and the correction SN ratio gain is substantially constant for any block, and an occurrence of detection delay or erroneous detection can be suppressed.

As described above, when levels of the SN ratio gain between the blocks can be made the same degree by calculating the SN ratio gain (correction SN ratio gain) via the difference between the total value of the larger-is-better SN ratios at the first level and the total value of the larger-is-better SN ratios at the second level without calculating an average value by dividing by a value corresponding to the size (number of sensors) of the orthogonal array, a common alarm threshold value is set throughout all the blocks in the multi-MT method, so that the factor of the abnormality can be specified with high accuracy at an early stage for any block.

### Modification Example of Correction SN Ratio Gain

The calculation method for a correction SN ratio gain is not limited to the above method. For example, the following may be performed. That is, the SN ratio gain calculation unit 341 calculates the correction SN ratio gain via a difference between a value obtained by multiplying the average value of the larger-is-better SN ratios at the first level by the number of the sensors, which correspond to the orthogonal array thereof and are used for creating the unit space, and a value obtained by multiplying the average value of the larger-is-better SN ratios at the second level by the number of the sensors, which correspond to the orthogonal array thereof and are used for creating the unit space, among the larger-is-better SN ratios calculated for each row of the two-level orthogonal array. For example, regarding a correspondence table of FIG. 2, the correction SN ratio gain of the sensor 1 is calculated by Equation (2).

$$Correction SN ratio gain of sensor 1 = ( ( η 1 + η 3 + η 5 + η 6 + η 7 + η 11 ) \div 6 \times 11 ) - ( η 2 + η 4 + η 8 + η 9 + η 10 + η 12 ) \div 6 \times 11 ) \qquad ( {2}^{″} )$$

Here, η1, η3, η5, η6, η7, and η11 are the larger-is-better SN ratios calculated for the rows in which the sensor 1 is at the first level, and η12, η4, η18, η19, η10, and η12 are the larger-is-better SN ratios calculated for the rows in which the sensor 1 is at the second level. In this way, when the number of sensors is 11, “11” is multiplied by each of the average values of the larger-is-better SN ratios at the first level and the second level. When the number of sensors used in the other block is 4, “4” is multiplied by an SN ratio gain calculated for the sensors of the block. As a result, there is a possibility that a difference between the SN ratio gain of the two blocks can be reduced. A reference value may be set for the number of sensors, and a value standardized with the reference value may be multiplied by each of the average values of the larger-is-better SN ratios at the first level and the second level. For example, when the reference value of the number of sensors is set to 20, for the block having 11 sensors, 11÷20 is multiplied by each of the average values of the larger-is-better SN ratios at the first level and the second level instead of 11, and for the block having 4 sensors, 4÷20 is multiplied.

### Modification Example of Setting Method for Alarm Threshold Value

The SN ratio gain may be calculated in the same manner as in a general calculation method, and an alarm threshold value may be set for each block. More specifically, the alarm threshold value is set for each block such that the alarm threshold value has a negative correlation with an orthogonal array size of the block or with the number of sensors used for creating unit spaces of the block. For example, the alarm threshold value may be set to be inversely proportional to the orthogonal array size or to the number of sensors of each block.

### (Operation)

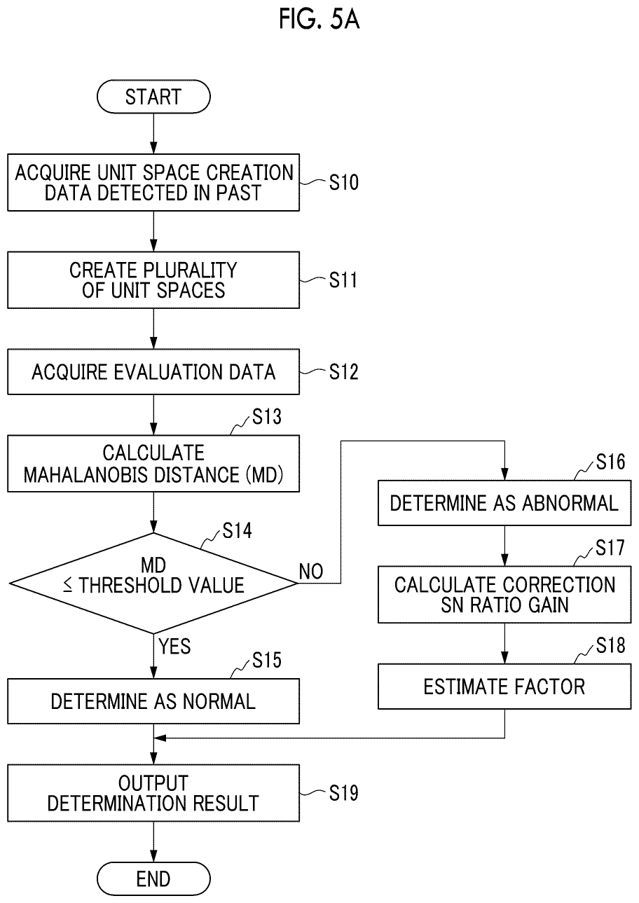

Next, with reference to FIGS. 5A and 5B, a flow of monitoring processing of the plant 20 via the monitoring device 30 will be described. FIG. 5A is a flowchart showing an example of plant monitoring processing according to the embodiment.

Prior to monitoring of the plant 20, a unit space used in the multi-MT method is created. The data acquisition unit 31 acquires the unit space creation data detected in the past (step S10). The data acquisition unit 31 acquires the unit space creation data detected by the sensors 1 to n when the plant 20 is operated normally, and stores the acquired unit space creation data in the storage unit 36. Next, the unit space creation unit 32 reads out the unit space creation data from the storage unit 36 to create a plurality of the unit spaces (step S11). The unit space creation unit 32 creates, for each operation mode of the plant 20, for example, when the plant is operated at a target operation load, a unit space (unit space for a rated load, unit space for a 50-load band, . . . and the like) for each operation load by using unit space creation data detected by a sensor required for evaluating the plant 20 in the operation load. For example, the unit space creation unit 32 creates, for each monitoring target of the plant 20, a unit space (unit space for the blade pass temperature, unit space for the bearing, . . . and the like) for each monitoring target by using unit space creation data detected by a sensor required for evaluating the monitoring target.

When the plurality of unit spaces are created, the monitoring device 30 starts to monitor the state of the plant 20. The data acquisition unit 31 acquires the evaluation data detected by the sensors 1 to n from the plant 20 during the operation (step S12). Next, the state evaluation unit 33 selects a unit space required for determining the state of the plant 20, and calculates a Mahalanobis distance (MD) between the evaluation data acquired in step S12 and each selected unit space (step S13). For example, if it is assumed that the plant 20 is currently operated at a rated load, it is determined that, in the monitoring of the plant 20 during the rated load operation, the rated load operation unit space and a unit space for each of a plurality of the monitoring targets are used, the rated load operation unit space is created by the unit space creation data detected by the sensors 1 to 11, and the unit space for the blade pass temperature among the unit spaces for each of the plurality of monitoring targets is created by unit space creation data detected by sensors 12 to 40. The state evaluation unit 33 calculates the Mahalanobis distance between an aggregate of the evaluation data detected by the sensors 1 to 11 among the evaluation data acquired by the data acquisition unit 31 and the rated load operation unit space. Further, the state evaluation unit 33 calculates the Mahalanobis distance between an aggregate of evaluation data detected by the sensors 12 to 40 among the evaluation data acquired by the data acquisition unit 31 and the unit space for the blade pass temperature. The state evaluation unit 33 also calculates the Mahalanobis distance for the unit spaces of other monitoring targets in the same manner.

Next, the state evaluation unit 33 compares the Mahalanobis distance for each unit space calculated in step S13 with the predetermined threshold value, and when the Mahalanobis distance is equal to or less than the threshold value (step S14; Yes), the state evaluation unit 33 determines that the state of the plant 20 is normal (step S15), and when the Mahalanobis distance exceeds the threshold value (step S14; No), the state evaluation unit 33 determines that the state of the plant 20 is abnormal (step S16).

When it is determined that the state of the plant 20 is abnormal, the SN ratio gain calculation unit 341 calculates the correction SN ratio gain (step S17). The SN ratio gain calculation unit 341 calculates the correction SN ratio gain for each unit space and for each sensor via the method described with reference to FIG. 2. A flow of the processing will be described with reference to FIG. 5B.

Next, the factor estimation unit 34 estimates the factor of the abnormality (step S18). For example, the factor estimation unit 34 compares a predetermined alarm threshold value set in common to all the unit spaces with the correction SN ratio gain for each unit space and for each sensor, which is calculated in step S17, and extracts the correction SN ratio gain exceeding the alarm threshold value. When the correction SN ratio gain that exceeds the alarm threshold value is not present, a predetermined number of the correction SN ratio gains having values close to the alarm threshold value may be extracted in order. The factor estimation unit 34 estimates that detection data detected by a sensor corresponding to the extracted correction SN ratio gain indicates the factor of the abnormality, and specifies the sensor as a sensor related to the factor of the abnormality.

Next, the output unit 35 outputs a determination result to a display device or the like (step S19). For example, when it is determined that the state of the plant is normal, the output unit 35 outputs that the plant 20 is normal. When it is determined that the state of the plant is abnormal, the output unit 35 outputs a fact that the plant 20 is abnormal, along with the sensor specified as being related to the factor of the abnormality or the detection data detected by the sensor.

Next, calculation processing for a correction SN ratio gain (step S17) will be described with reference to FIG. 5B. FIG. 5B is a flowchart showing an example of correction SN ratio gain calculation processing according to the embodiment. First, the SN ratio gain calculation unit 341 creates an orthogonal array for each unit space (for each block) (step S20). The SN ratio gain calculation unit 341 allocates, for each unit space used for determining the state of the plant 20, each of the sensors used for creating the unit space among the sensors 1 to n to each column of the two-level orthogonal array to create the orthogonal array for each unit space. Next, the SN ratio gain calculation unit 341 calculates the larger-is-better SN ratio of each row of the orthogonal array for the orthogonal array created for each unit space using Equation (1) (step S21). Next, the SN ratio gain calculation unit 341 calculates the correction SN ratio gain (step S22). For example, the SN ratio gain calculation unit 341 calculates, for each unit space and for each sensor, a difference between a total value of the larger-is-better SN ratios at the first level and a total value of the larger-is-better SN ratios at the second level in the orthogonal array of the unit space to calculate the correction SN ratio gain for each unit space and for each sensor. Alternatively, the SN ratio gain calculation unit 341 may calculate the correction SN ratio gain by calculating, for each unit space and for each sensor, a difference between a value obtained by multiplying an average value of the larger-is-better SN ratios at the first level by a value corresponding to the number of sensors used for creating the unit spaces (for example, the number of sensors or a value obtained by dividing the number of sensors by the reference value) and a value obtained by multiplying an average value of the larger-is-better SN ratios at the second level by the value corresponding to the number of sensors used for creating the unit spaces. As a result, a variation in a level of the magnitude of the SN ratio gain due to the difference in the number of sensors for each unit space is suppressed, and each magnitude is made uniform.

### (Effects)

As described above, when the factor of the abnormality is estimated by the SN ratio gain based on the orthogonal array, the magnitude of the SN ratio gain varies for each of the plurality of unit spaces due to the difference in the number of sensors used for creating the unit spaces. Meanwhile, with the monitoring device 30 according to the present embodiment, the correction SN ratio gain is calculated by performing a correction to reduce the variation between the plurality of unit spaces. As a result, even when a threshold value (alarm threshold value) common to the plurality of unit spaces is set, the factor of the abnormality can be estimated with high accuracy at an early stage.

In the flowchart of FIG. 5A, the SN ratio gain calculation unit 341 calculates the correction SN ratio gain, but for each unit space, a threshold value that is inversely proportional to the number of sensors used for creating the unit spaces may be set, and the SN ratio gain calculation unit 341 may calculate the general SN ratio gain. Even with such a configuration, it is possible to suppress the occurrence of erroneous detection or detection delay due to the variation in the SN ratio gain for each of the plurality of unit spaces.

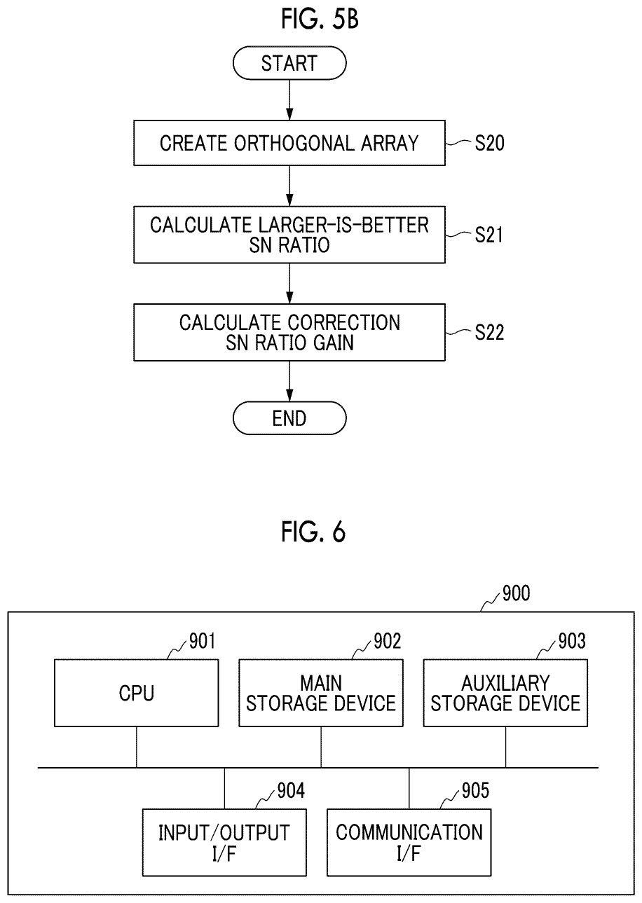

FIG. 6 is a diagram showing an example of a hardware configuration of the monitoring device according to the embodiment.

A computer 900 includes a CPU 901, a main storage device 902, an auxiliary storage device 903, an input/output interface 904, and a communication interface 905.

The monitoring device 30 is implemented in the computer 900. Each of the functions described above is stored in the auxiliary storage device 903 in the form of a program. The CPU 901 reads out the program from the auxiliary storage device 903, expands the program in the main storage device 902, and executes the above processing according to the program. The CPU 901 allocates a storage area in the main storage device 902 according to the program. The CPU 901 allocates a storage area for storing data being processed in the auxiliary storage device 903 according to the program.

By recording a program for realizing all or some of the functions of the monitoring device 30 on a computer-readable recording medium, and by reading the program recorded on the recording medium into a computer system and executing the read program, the processes by each functional unit may be performed. The “computer system” herein includes an OS and hardware such as a peripheral device. The “computer system” also includes a homepage providing environment (or display environment) when a WWW system is used. The “computer-readable recording medium” refers to a portable medium such as a CD, a DVD, or a USB, or a storage device such as a hard disk built into the computer system. In a case where the program is distributed to the computer 900 by a communication line, the computer 900 to which the program is distributed may expand the program in the main storage device 902 and execute the above processing. The above program may be for realizing a part of the above functions, or may further realize the above functions in combination with a program already recorded in the computer system.

As described above, some embodiments according to the present disclosure have been described, but all of these embodiments are presented as examples and are not intended to limit the scope of the invention. These embodiments can be implemented in various other forms, and various omissions, replacements, and changes can be made without departing from the gist of the invention. These embodiments and modifications thereof are included in the scope of the invention described in the claims and the equivalent scope thereof, as well as in the scope and gist of the invention.

### Additional Notes

The monitoring method, the calculation method for an SN ratio gain, the monitoring device, and the program described in each embodiment are understood, for example, as follows.
(1) A monitoring method according to a first aspect includes a step of acquiring unit space creation data, which is detected by a plurality of sensors 1 to n provided in a plant 20 and is for creating a plurality of unit spaces that are predetermined depending on an operation mode and/or a monitoring target (S10), a step of creating the plurality of unit spaces based on the unit space creation data detected by the sensor required for creating each of the unit spaces (S11), a step of acquiring evaluation data, which is detected by the plurality of sensors and is an aggregate of data for evaluating a state of the plant (S12), a step of obtaining a Mahalanobis distance of the evaluation data based on at least some of the plurality of unit spaces (S13), a step of determining the state of the plant based on the Mahalanobis distance and on a predetermined threshold value (S14 to S16), and a step of estimating a factor of an abnormality when the abnormality is determined in the step of determining the state of the plant (S17 and S18), in which the step of estimating the factor of the abnormality includes a step of allocating, for each of the unit spaces used for determining the state, each of the sensors used for creating the unit space to a two-level orthogonal array with a use of the sensor as a first level and a non-use of the sensor as a second level to create an orthogonal array for each of the unit spaces, a step of calculating a larger-is-better SN ratio of each row of the orthogonal array for each of the orthogonal arrays for each of the unit spaces, a step of calculating an SN ratio gain by calculating a difference between a total value of the larger-is-better SN ratios at the first level and a total value of the larger-is-better SN ratios at the second level for each of the sensors in each of the orthogonal arrays for each of the unit spaces, and a step of specifying the sensor for which the SN ratio gain exceeding a predetermined threshold value (alarm threshold value) for the SN ratio gain is calculated as a sensor related to the factor of the abnormality, based on the SN ratio gain calculated for each of the sensors and on the threshold value for the SN ratio gain.

As a result, in a monitoring method in which the multi-MT method is used to determine whether the plant is normal or abnormal by comparing the Mahalanobis distance with the threshold value and the factor of the abnormality is estimated by the SN ratio gain in a case of being determined that the plant is abnormal, it is possible to reduce erroneous detection or detection delay of the factor of the abnormality and to estimate the factor of the abnormality at an early stage.
(2) A monitoring method according to a second aspect is the monitoring method of (1), and in the step of calculating the SN ratio gain, instead of calculating the difference between the total value of the larger-is-better SN ratios at the first level and the total value of the larger-is-better SN ratios at the second level, the SN ratio gain is calculated by calculating a difference between a value obtained by multiplying an average value of the larger-is-better SN ratios at the first level by a value corresponding to the number of the sensors used for creating the unit spaces and a value obtained by multiplying an average value of the larger-is-better SN ratios at the second level by the value corresponding to the number of the sensors used for creating the unit spaces.

As a result, the same effect as the monitoring method according to the first aspect can be obtained.
(3) A monitoring method according to a third aspect is the monitoring method of (1), in the step of calculating the SN ratio gain, instead of calculating a difference between a total value of SN ratios at the first level and a total value of SN ratios at the second level, the SN ratio gain is calculated by calculating a difference between an average value of the larger-is-better SN ratios at the first level and an average value of the larger-is-better SN ratios at the second level, and in the step of specifying the factor, the factor of the abnormality is specified based on a threshold value for the SN ratio gain, which is determined for each of the unit spaces to be inversely proportional to the number of the sensors used for creating the unit spaces.

As a result, the same effect as the monitoring method according to the first aspect can be obtained.
(4) A calculation method for an SN ratio gain according to a fourth aspect includes, when a plurality of unit spaces are created based on data detected by a plurality of sensors 1 to n provided in a plant 20, and a state of the plant is evaluated by a multi-MT method based on at least some of the plurality of unit spaces, a step of allocating, for each of the unit spaces, each of the sensors used for creating the unit space to a two-level orthogonal array with a use of the sensor as a first level and a non-use of the sensor as a second level to create an orthogonal array for each of the unit spaces (S20), a step of calculating a larger-is-better SN ratio of each row of the orthogonal array for each of the orthogonal arrays for each of the unit spaces (S21), and a step of calculating an SN ratio gain by calculating a difference between a total value of the larger-is-better SN ratios at the first level and a total value of the larger-is-better SN ratios at the second level for each of the sensors in each of the orthogonal arrays for each of the unit spaces (S22). As a result, the SN ratio gain in which the level of the magnitude of the SN ratio gain due to the orthogonal array size for each unit space in the multi-MT method is corrected can be calculated.
(5) A calculation method for an SN ratio gain according to a fifth aspect is the calculation method for an SN ratio gain of (4), and in the step of calculating the SN ratio gain, instead of calculating the difference between the total value of the larger-is-better SN ratios at the first level and the total value of the larger-is-better SN ratios at the second level, the SN ratio gain is calculated by calculating a difference between a value obtained by multiplying an average value of the larger-is-better SN ratios at the first level by a value corresponding to the number of the sensors used for creating the unit spaces and a value obtained by multiplying an average value of the larger-is-better SN ratios at the second level by the value corresponding to the number of the sensors used for creating the unit spaces.

As a result, the same effect as the calculation method for an SN ratio gain according to the fourth aspect can be obtained.
(6) A monitoring device 30 according to a sixth aspect includes means (data acquisition unit 31) for acquiring unit space creation data, which is detected by a plurality of sensors provided in a plant and is for creating a plurality of unit spaces that are predetermined depending on an operation mode and/or a monitoring target, means (unit space creation unit 32) for creating the plurality of unit spaces based on the unit space creation data detected by the sensor required for creating each of the unit spaces, means (data acquisition unit 31) for acquiring evaluation data, which is detected by the plurality of sensors and is an aggregate of data for evaluating a state of the plant, means (state evaluation unit 33) for obtaining a Mahalanobis distance of the evaluation data based on at least some of the plurality of unit spaces, means (state evaluation unit 33) for determining the state of the plant based on the Mahalanobis distance and on a predetermined threshold value, and means (factor estimation unit 34) for estimating a factor of an abnormality when the abnormality is determined in the step of determining the state of the plant, in which the means (factor estimation unit 34, SN ratio gain calculation unit 341) for estimating the factor of the abnormality allocates, for each of the unit spaces used for determining the state, each of the sensors used for creating the unit space to a two-level orthogonal array with a use of the sensor as a first level and a non-use of the sensor as a second level to create an orthogonal array for each of the unit spaces, calculates a larger-is-better SN ratio of each row of the orthogonal array for each of the orthogonal arrays for each of the unit spaces, calculates an SN ratio gain by calculating a difference between a total value of the larger-is-better SN ratios at the first level and a total value of the larger-is-better SN ratios at the second level for each of the sensors in each of the orthogonal arrays for each of the unit spaces, and specifies the sensor for which the SN ratio gain exceeding a predetermined threshold value for the SN ratio gain is calculated as a sensor related to the factor of the abnormality, based on the SN ratio gain calculated for each of the sensors and on the threshold value for the SN ratio gain.
(7) A program according to a seventh aspect causes a computer to execute a process including a step of acquiring unit space creation data, which is detected by a plurality of sensors provided in a plant and is for creating a plurality of unit spaces that are predetermined depending on an operation mode and/or a monitoring target, a step of creating the plurality of unit spaces based on the unit space creation data detected by the sensor required for creating each of the unit spaces, a step of acquiring evaluation data, which is detected by the plurality of sensors and is an aggregate of data for evaluating a state of the plant, a step of obtaining a Mahalanobis distance of the evaluation data based on at least some of the plurality of unit spaces, a step of determining the state of the plant based on the Mahalanobis distance and on a predetermined threshold value, and a step of estimating a factor of an abnormality when the abnormality is determined in the step of determining the state of the plant, in which the step of estimating the factor of the abnormality includes a step of allocating, for each of the unit spaces used for determining the state, each of the sensors used for creating the unit space to a two-level orthogonal array with a use of the sensor as a first level and a non-use of the sensor as a second level to create an orthogonal array for each of the unit spaces, a step of calculating a larger-is-better SN ratio of each row of the orthogonal array for each of the orthogonal arrays for each of the unit spaces, a step of calculating an SN ratio gain by calculating a difference between a total value of the larger-is-better SN ratios at the first level and a total value of the larger-is-better SN ratios at the second level for each of the sensors in each of the orthogonal arrays for each of the unit spaces, and a step of specifying the sensor for which the SN ratio gain exceeding a predetermined threshold value for the SN ratio gain is calculated as a sensor related to the factor of the abnormality, based on the SN ratio gain calculated for each of the sensors and on the threshold value for the SN ratio gain.

### INDUSTRIAL APPLICABILITY

According to the monitoring method, the calculation method for an SN ratio gain, the monitoring device, and the program described above, it is possible to calculate an SN ratio gain less affected by a size of an orthogonal array. According to the monitoring method, the monitoring device, and the program described above, a factor of an abnormality can be estimated with high accuracy at an early stage.

### REFERENCE SIGNS LIST

10: monitoring system
20: plant
21: machine
1 to n: sensor
30: monitoring device
31: data acquisition unit
32: unit space creation unit
33: state evaluation unit
34: factor estimation unit
341: SN ratio gain calculation unit
35: output unit
36: storage unit
900: computer
901: CPU
902: main storage device
903: auxiliary storage device
904: input/output interface
905: communication interface

1. A monitoring method comprising:
a step of acquiring unit space creation data, which is detected by a plurality of sensors provided in a plant and is for creating a plurality of unit spaces that are predetermined depending on an operation mode and/or a monitoring target;
a step of creating the plurality of unit spaces based on the unit space creation data detected by the sensor required for creating each of the unit spaces;
a step of acquiring evaluation data, which is detected by the plurality of sensors and is an aggregate of data for evaluating a state of the plant;
a step of obtaining a Mahalanobis distance of the evaluation data based on at least some of the plurality of unit spaces;
a step of determining the state of the plant based on the Mahalanobis distance and on a predetermined threshold value; and
a step of estimating a factor of an abnormality when the abnormality is determined in the step of determining the state of the plant,
wherein the step of estimating the factor of the abnormality includes
a step of allocating, for each of the unit spaces used for determining the state, each of the sensors used for creating the unit space to a two-level orthogonal array with a use of the sensor as a first level and a non-use of the sensor as a second level to create an orthogonal array for each of the unit spaces,
a step of calculating a larger-is-better SN ratio of each row of the orthogonal array for each of the orthogonal arrays for each of the unit spaces,
a step of calculating an SN ratio gain by calculating a difference between a total value of the larger-is-better SN ratios at the first level and a total value of the larger-is-better SN ratios at the second level for each of the sensors in each of the orthogonal arrays for each of the unit spaces, and
a step of specifying the sensor for which the SN ratio gain exceeding a predetermined threshold value for the SN ratio gain is calculated as a sensor related to the factor of the abnormality, based on the SN ratio gain calculated for each of the sensors and on the threshold value for the SN ratio gain.

2. The monitoring method according to claim 1,
wherein, in the step of calculating the SN ratio gain, instead of calculating the difference between the total value of the larger-is-better SN ratios at the first level and the total value of the larger-is-better SN ratios at the second level,
the SN ratio gain is calculated by calculating a difference between a value obtained by multiplying an average value of the larger-is-better SN ratios at the first level by a value corresponding to the number of the sensors used for creating the unit spaces and a value obtained by multiplying an average value of the larger-is-better SN ratios at the second level by the value corresponding to the number of the sensors used for creating the unit spaces.

3. The monitoring method according to claim 1,
wherein, in the step of calculating the SN ratio gain, instead of calculating a difference between a total value of SN ratios at the first level and a total value of SN ratios at the second level,
the SN ratio gain is calculated by calculating a difference between an average value of the larger-is-better SN ratios at the first level and an average value of the larger-is-better SN ratios at the second level, and
in the step of specifying, the sensor is specified based on a threshold value for the SN ratio gain, which is determined for each of the unit spaces to be inversely proportional to the number of the sensors used for creating the unit spaces.

4. A calculation method for an SN ratio gain, the calculation method comprising:
when a plurality of unit spaces are created based on data detected by a plurality of sensors provided in a plant, and a state of the plant is evaluated by a multi-MT method based on at least some of the plurality of unit spaces,
a step of allocating, for each of the unit spaces, each of the sensors used for creating the unit space to a two-level orthogonal array with a use of the sensor as a first level and a non-use of the sensor as a second level to create an orthogonal array for each of the unit spaces;
a step of calculating a larger-is-better SN ratio of each row of the orthogonal array for each of the orthogonal arrays for each of the unit spaces; and
a step of calculating an SN ratio gain by calculating a difference between a total value of the larger-is-better SN ratios at the first level and a total value of the larger-is-better SN ratios at the second level for each of the sensors in each of the orthogonal arrays for each of the unit spaces.

5. The calculation method for an SN ratio gain according to claim 4,
wherein, in the step of calculating the SN ratio gain, instead of calculating the difference between the total value of the larger-is-better SN ratios at the first level and the total value of the larger-is-better SN ratios at the second level,
the SN ratio gain is calculated by calculating a difference between a value obtained by multiplying an average value of the larger-is-better SN ratios at the first level by a value corresponding to the number of the sensors used for creating the unit spaces and a value obtained by multiplying an average value of the larger-is-better SN ratios at the second level by the value corresponding to the number of the sensors used for creating the unit spaces.

6. A monitoring device comprising:
means for acquiring unit space creation data, which is detected by a plurality of sensors provided in a plant and is for creating a plurality of unit spaces that are predetermined depending on an operation mode and/or a monitoring target;
means for creating the plurality of unit spaces based on the unit space creation data detected by the sensor required for creating each of the unit spaces;
means for acquiring evaluation data, which is detected by the plurality of sensors and is an aggregate of data for evaluating a state of the plant;
means for obtaining a Mahalanobis distance of the evaluation data based on at least some of the plurality of unit spaces;
means for determining the state of the plant based on the Mahalanobis distance and on a predetermined threshold value; and
means for estimating a factor of an abnormality when the abnormality is determined in the step of determining the state of the plant,
wherein the means for estimating the factor of the abnormality
allocates, for each of the unit spaces used for determining the state, each of the sensors used for creating the unit space to a two-level orthogonal array with a use of the sensor as a first level and a non-use of the sensor as a second level to create an orthogonal array for each of the unit spaces,
calculates a larger-is-better SN ratio of each row of the orthogonal array for each of the orthogonal arrays for each of the unit spaces,
calculates an SN ratio gain by calculating a difference between a total value of the larger-is-better SN ratios at the first level and a total value of the larger-is-better SN ratios at the second level for each of the sensors in each of the orthogonal arrays for each of the unit spaces, and
specifies the sensor for which the SN ratio gain exceeding a predetermined threshold value for the SN ratio gain is calculated as a sensor related to the factor of the abnormality, based on the SN ratio gain calculated for each of the sensors and on the threshold value for the SN ratio gain.

7. A program causing a computer to execute a process comprising:
a step of acquiring unit space creation data, which is detected by a plurality of sensors provided in a plant and is for creating a plurality of unit spaces that are predetermined depending on an operation mode and/or a monitoring target;
a step of creating the plurality of unit spaces based on the unit space creation data detected by the sensor required for creating each of the unit spaces;
a step of acquiring evaluation data, which is detected by the plurality of sensors and is an aggregate of data for evaluating a state of the plant;
a step of obtaining a Mahalanobis distance of the evaluation data based on at least some of the plurality of unit spaces;
a step of determining the state of the plant based on the Mahalanobis distance and on a predetermined threshold value; and
a step of estimating a factor of an abnormality when the abnormality is determined in the step of determining the state of the plant,
wherein the step of estimating the factor of the abnormality includes
a step of allocating, for each of the unit spaces used for determining the state, each of the sensors used for creating the unit space to a two-level orthogonal array with a use of the sensor as a first level and a non-use of the sensor as a second level to create an orthogonal array for each of the unit spaces,
a step of calculating a larger-is-better SN ratio of each row of the orthogonal array for each of the orthogonal arrays for each of the unit spaces,
a step of calculating an SN ratio gain by calculating a difference between a total value of the larger-is-better SN ratios at the first level and a total value of the larger-is-better SN ratios at the second level for each of the sensors in each of the orthogonal arrays for each of the unit spaces, and
a step of specifying the sensor for which the SN ratio gain exceeding a predetermined threshold value for the SN ratio gain is calculated as a sensor related to the factor of the abnormality, based on the SN ratio gain calculated for each of the sensors and on the threshold value for the SN ratio gain.
